(19) United States
(12) Patent Application Publication
(10) Pub. No.: US 2006/0224697 A1
(43) Pub. Date: Oct. 5, 2006

(54) Method to display and manipulate new content on top of an existing web page

(76) Inventor: Stephen R. Norris, Tucson, AZ (US)

Correspondence Address: DALE F. REGELMAN, LAW OFFICE OF DALE F. REGELMAN, P.C., 4231 SOUTH FREMONT AVENUE, TUCSON, AZ, 85714, US

(21) Appl. No.: 11/396,662

(22) Filed: Apr. 3, 2006

Related U.S. Application Data
(60) Provisional application No. 60/667,941, filed on Apr. 4, 2005.

(51) Int. Cl. G06F 15/16

(52) U.S. Cl. 709/218; 715/513

(57) ABSTRACT

A method is disclosed to display and manipulate new content on top of an existing web page and republish the web page to include the new content. The method provides a computing device an HTA application comprising an IFRAME, a single <DIV> layer, and a Flash Application embedded in said <DIV> layer. The method loads a web page into the IFRAME, loads a one or more New Content Objects into the Flash Application, and displays on a display device in a WYSIWYG format the one or more New Content Objects and the existing web page, such that the one or more New Content Objects appear on top of the existing web page. The method provides for the publishing the new web page to include a Content Loader, a storage folder containing the new content files, and an inventory to be read by the Content Loader containing a list of new content and the location and display parameters for each.

### CROSS REFERENCE TO RELATED APPLICATIONS

This Application claims priority from a U.S. Provisional Application having Ser. No. 60/667,941.

### FIELD OF THE INVENTION

The invention is directed to a method to display and manipulate new content on top of an existing web page.

### BACKGROUND OF THE INVENTION

Using prior art methods to author or modify web pages, especially add new content which is “transparent”—that is appears to float above the original web page while allowing the original web page to show through in places where the new content is not, is cumbersome, requiring the addition of a <DIV> tag for each layer of new content. Additionally, prior art methods do not allow for the addition of new content in transparent layers in a What You See Is What You Get (WYSIWYG) format. As an example, using prior art methods in combination a program sold in commerce under the name MACROMEDIA DREAMWEAVER requires adding a <DIV> tag for each transparent layer. While adding the new content, MACROMEDIA DREAMWEAVER requires switching back and forth between an authoring mode and a “Preview in Browser” mode.

What is needed is a method and a computer program product implementing that method that simplifies the addition of New Content Objects to an existing web page without creating multiple <DIV> layers. Applicant's computer program product and method allows a user to add transparent New Content Objects to an existing web page by creating a single <DIV> layer in and embedding a Content Loader with wmode tags set to “transparent”. Any New Content that the Content Loader loads, takes on the transparency of the Content Loader.

Applicant's method, and computer program product implementing that method, further permits a user to add new content to an existing web page all the while viewing the modified web page in a WYSYWIG environment.

### SUMMARY OF THE INVENTION

Applicant's invention comprises a method to display and manipulate new content on top of an existing web page. The method provides a computing device comprising a display device and Applicant's computer program product, wherein that computer program product comprises an HTA application comprising an IFRAME, a single <DIV> layer, and a Flash Application embedded in that <DIV> layer. The method loads a web page into the IFRAME, loads one or more New Content Objects into the Flash Application, and displays on the display device in a WYSIWYG (What You See Is What You Get) format the one or more New Content Objects and the existing web page, such that the one or more New Content Objects appear on top of the existing web page. The method republishes the web page and provides the necessary content and Content Loader such that the web page can display the new content.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram showing certain elements of Applicant's computer program product which implements Applicant's method to display and manipulate new content on top of an existing web page;

FIG. 2 is a flow chart summarizing certain initial steps of Applicant's method;

FIG. 3 is a flow chart summarizing certain additional steps of Applicant's method;

FIG. 4 is a flow chart summarizing certain additional steps of Applicant's method; and

FIG. 5 is a block diagram showing a computing device comprising Applicant's computer program product, a processor, memory, an information storage medium, and a display device.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

As a general matter, HTML documents, such as web pages accessed by a computing device and displayed using a browser program, cannot access content on the computing device. Such security measures prevent unauthorized access to the files disposed on the computing device, when for example displaying web pages accessed via the Internet. As a result, a web page cannot be modified by adding new content when that web page is loaded into, and being displayed using, a browser application.

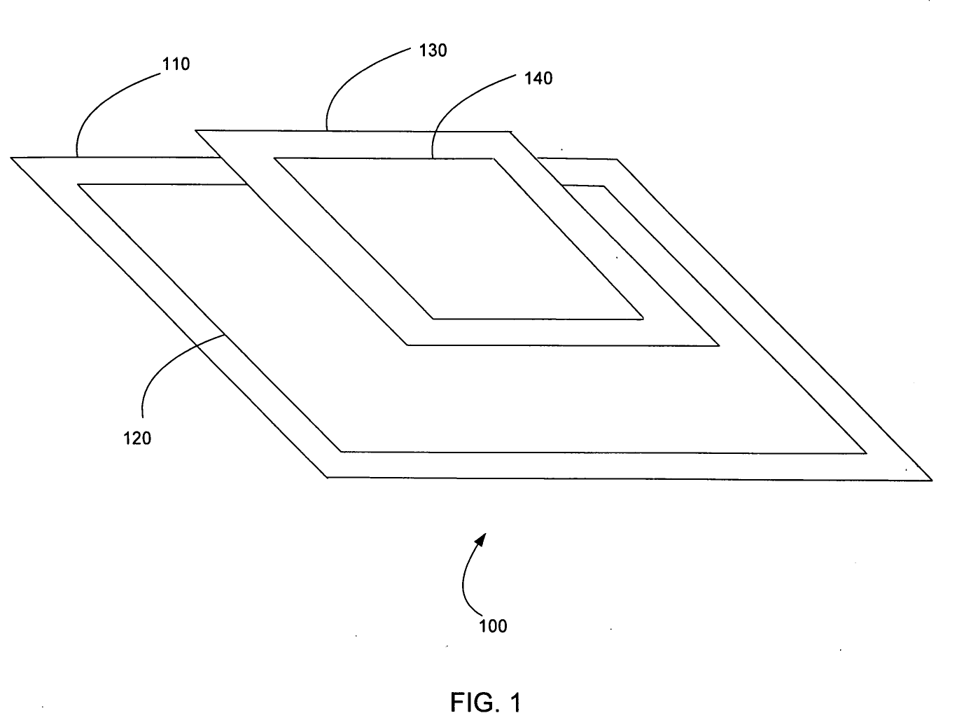

On the other hand, when using Applicant's computer program product 100 (FIG. 1) the restrictions against allowing scripts to manipulate the client machine are lifted. Rather, all command codes are supported without scripting limitations, and an Applicant's computer program product 100 has read/write access to the files and system registry on the client machine.

Referring now to FIG. 1, Applicant's method to add new content to an existing web page utilizes computer program product 100. Computer program product 100 comprises HTA Application (.hta) 110, IFRAME 120, and Flash Application (.swf) 140 embedded in a <DIV> layer 130. In the illustrated embodiment of FIG. 1, <DIV> layer 130 is shown disposed “above” the IFRAME 120 meaning that the <DIV> layer 130 appears later in the .html code than IFRAME 120.

As those skilled in the art will appreciate, an inline frame comprises a construct which embeds content into an HTML document so that embedded content is displayed inside a subwindow of the browser's window. IFRAME 120 serves to display a selected target web page to which content will be added using Applicant's method. Selected new content is loaded into Flash Application 140 such that the new content appears to be floating above the target web page displayed in IFRAME 120.

By “Flash Application,” Applicant means any application that allows transparent viewing through itself, wherein that application can load external content into itself, and wherein that application can reside above an underlying web page's content. In certain embodiments, Flash Application 140 comprises an application created using a product sold in commerce by ADOBE under the name MACROMEDIA FLASH.

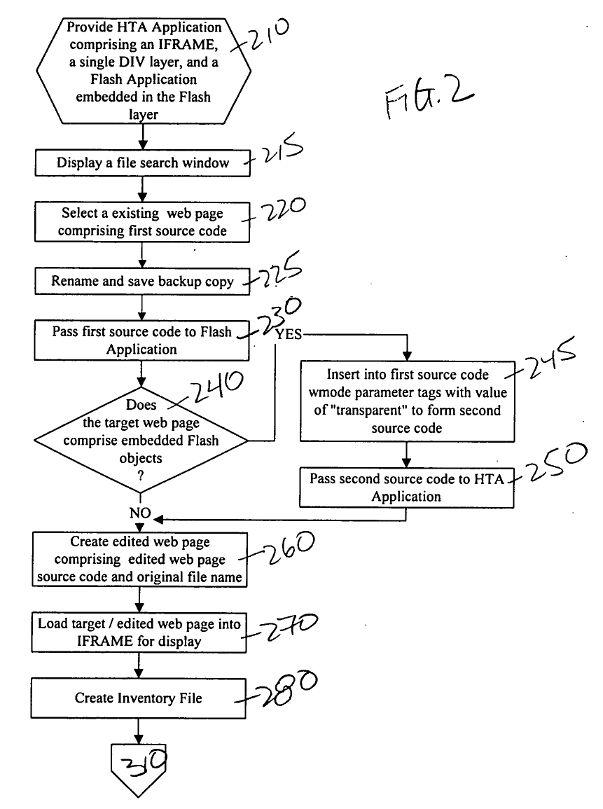

Applicant's invention comprises a method to display and manipulate new content on top of an existing web page, while that web page is displayed in a browser application. Applicant's method further publishes a new web page comprising the existing web page in combination with the new content. FIGS. 2, 3, and 4, summarize the steps of Applicant's method.

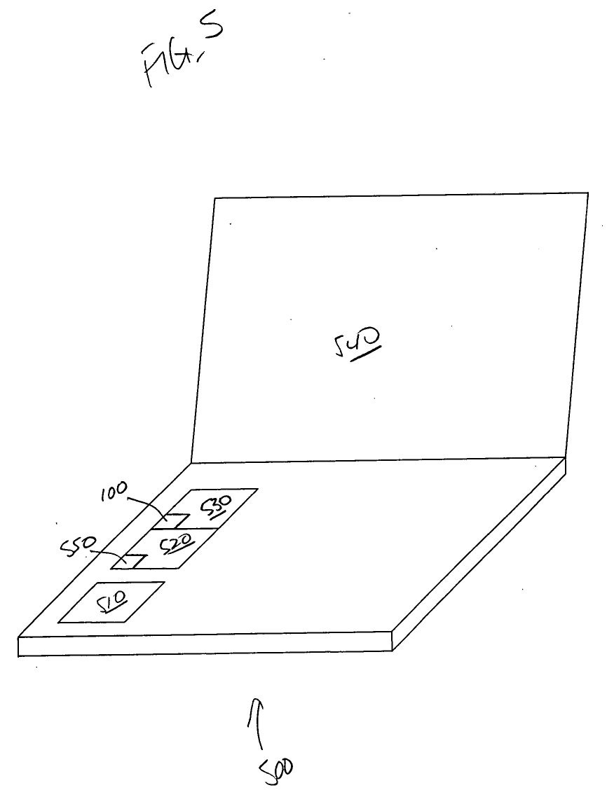

Referring now to FIG. 2, in step 210 Applicant's method provides a computing device, such as computing device 500 (FIG. 5) comprising a processor, such as processor 510, memory, such as memory 520, and one or more information storage media, such as information storage medium 530, and Applicant's computer program product 100 running on that computing device, wherein Applicant's computer program product 100 comprises an IFRAME, such as IFRAME 120, a single <DIV> layer, such as <DIV> layer 130, wherein that <<DIV>> layer comprising a Flash Application, such as Flash Application 140 as described hereinabove.

As a general matter, the computing device of step 210 comprises a computer system, such as a mainframe, personal computer, workstation, and combinations thereof, including an operating system such as Windows, AIX, Unix, MVS, LINUX, etc. (Windows is a registered trademark of Microsoft Corporation; AIX is a registered trademark and MVS is a trademark of IBM Corporation; UNIX is a registered trademark in the United States and other countries licensed exclusively through The Open Group; and LINUX is a registered trademark of Linus Torvald).

In step 215, Applicant's method displays a file search window. In certain embodiments, in step 215 when prompted by user action, the embedded Flash Application 140 requests that HTA Application 110 display a file search window to allow the user to search for an existing web page (“target” page).

In step 220, Applicant's method selects an existing web page using the file search window of step 215. Applicant's method transitions from step 220 to step 225 wherein HTA Application 110 creates a backup copy of the existing web page and saves it under a new name. Applicant's method transitions from step 225 to step 230 wherein HTA Application 110 reads the existing web page and passes the web page's source code, i.e. first source code, to Flash Application 140. In certain embodiments, step 230 comprises passing first source code as a delimited string using setVariable.

Applicant's method transitions from step 230 to step 240 wherein the method determines if the target web page comprises embedded Flash objects. In certain embodiments, in step 240 Flash Application 140 determines if the target web page contains any embedded Flash objects.

If Applicant's method determines in step 240 that the target web page does not comprise one or more embedded Flash objects, then the method transitions from step 240 to step 260 Alternatively, if Applicant's method determines in step 240 that the target web page comprises one or more embedded Flash objects, then the method transitions from step 240 to step 245 wherein Flash Application 140 forms second source code by inserting, for each embedded Flash object, into the existing web page's first source code, wmode parameter tags (for each supported browser) to set the wmode for the object to transparent. In certain embodiments, the parameter tags consist of “<param name=wmode value=transparent>”. In certain embodiments, the parameter tags consist of <embed wmode=“transparent” wmodeFlag=“set” . . . ”. Step 250 is required for HTA Application 110 to later display new content on top of any embedded Flash objects the target page may already comprise.

Applicant's method transitions from step 245 to step 250 wherein Flash Application 140 then passes the second source code to HTA Application 110. Applicant's method transitions from step 240 to step 260 wherein the method creates an edited web page file comprising the original source code if the method does not use steps 245 and 250. Alternatively, the Applicant's method transitions from step 250 to 260 wherein the method creates an edited web page file comprising the second source code of step 245 if the method does use steps 245 and 250.

Applicant's method transitions from step 260 to step 270 wherein HTA Application 110 loads the edited web page of step 260 into IFRAME 220 for display to the user. Applicant's method transitions from step 270 to step 280 wherein the method creates a Content Inventory File. Applicant's method will later write to this Content Inventory File information related to, or comprising, certain selected New Content Objects, New Content Object Addresses, and/or New Content Object display attributes. In certain embodiments, step 280 comprises creating a database for the Content Inventory File. In certain embodiments, step 280 comprises creating an .xml file for the Content Inventory File.

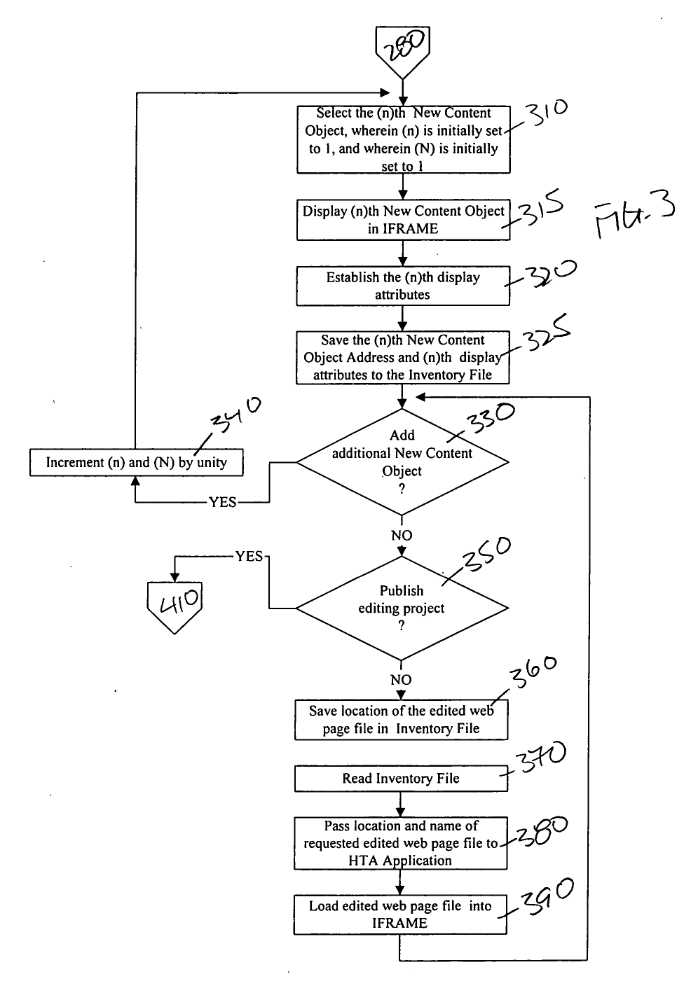

In the illustrated embodiment of FIG. 2, step 280 is performed after step 290 and before step 310. In other embodiments of Applicant's method, step 280 is performed any time prior to performing step 325 (FIG. 3).

Applicant's method transitions from step 280 to step 310 wherein the method selects the (n)th New Content Object, wherein (n) is initially set to 1, and wherein (N) is initially set to 1. In certain embodiments, in step 310 HTA Application 110 locates all the available New Content Objects written to the one or more information storage media disposed in the computing device of step 110, and passes that available content to Flash Application 140 for display. Using the displayed available content, the user then selects the (n)th New Content Object to add to the edited web page of step 270.

The New Content objects consist of any type of content that can be displayed via an Internet Browser. In certain embodiments, the (n)th New Content object comprises an audio file. In certain embodiments, the (n)th New Content object comprises an animation file. In certain embodiments, the (n)th New Content object comprises a movie file. In certain embodiments, the (n)th New Content object comprises an image file. In certain embodiments, the (n)th New Content object comprises a *.jpeg file. In certain embodiments, the (n)th New Content object comprises a *.gif file. In certain embodiments, the (n)th New Content object comprises a *.png file. In certain embodiments, the (n)th New Content object comprises an *.swf file. In certain embodiments, the (n)th New Content object comprises *.flv file. In certain embodiments, the (n)th New Content object comprises an *.mp3 file. In certain embodiments, the (n)th New Content object comprises a *.wav file.

Applicant's method transitions from step 310 to step 315 wherein Flash Application 140 loads selected New Content Object into itself such that the New Content Object appears to the user to be on top of the edited web page of step 270. Using Applicant's computer program product 100, the New Content Object selected in step 310 is displayed in step 315 in what is sometimes referred to as a “WYSIWYG” or a “What You See Is What You Get” format. More specifically, the New Content Object displayed in step 315 is shown substantially as the edited web page would be viewed using a conventional browser program with the addition of some features to assist with the manipulation of the New Content Object during the addition of the new content.

Using prior art methods to author or modify web pages, New Content is displayed in an “authoring mode,” wherein that authoring mode does not accurately show the edited web page in a browser format or WSIWYG mode. Rather, in order to view the edited web page as that edited page would be displayed in a browser program, the user must switch from the “authoring mode” to a “preview mode” which provides a truly WSIWYG format. Applicant's computer program product 100 eliminates the need to repeatedly toggle between an authoring mode and a preview mode as new content is added to a web page.

Applicant's method transitions from step 315 to step 320 wherein the method establishes the (n)th display attributes for the (n)th New Content Object selected in step 310 and displayed in step 315. Flash Application 140 allows the user to manipulate the properties of the (n)th New Content Object such as but not limited to location, size, layering order, and the like, wherein those properties comprise the (n)th display attributes.

Applicant's method transitions from step 320 to step 325 wherein the method saves to the Content Inventory File of step 290 the (n)th New Content Object Address and the (n)th display attributes. Applicant's method transitions from step 325 to step 330 wherein the method determines whether to add additional New Content Objects. If Applicant's method elects to add another New Content Object, then the method transitions from step 330 to step 340 wherein the method increments (n) and (N) by unity. Applicant's method transitions from step 340 to step 310 and continues as described herein.

If Applicant's method elects in step 330 not to add another New Content Object, then the method determines whether to publish the editing project or to save the editing project. Applicant's computer program product 100 allows the user to save the edited web page of step 270 (FIG. 1) and the (N) New Content Objects selected in one or more iterations of step 310 as a “project” by passing from Flash Application 140 to HTA Application 110 as a delimited string the location of the edited web page and for each value of (n), the (n)th New Content Object Address and the (n)th display attributes.

If Applicant's method elects in step 350 to save the editing project, the method transitions from step 350 to step 360 wherein HTA Application 110 writes to an .xml Content Inventory File information including, but not limited to, the name and location of the edited web page of step 260, and for each value of (n) the (n)th New Content Object Address and the (n)th display attributes. In some embodiments, in step 360 Applicant's method writes to the database of step 280 information including, but not limited to, the name and location of the edited web page of step 260, and for each value of (n) the (n)th New Content Object Address and the (n)th display attributes.

When at a later time, the user in step 370 prompts Applicant's computer program product 100 to open the saved project, Flash Application 140 reads the Content Inventory and retrieves the name and location of the edited web page. In step 380, Flash Application 140 passes the location and the name of the edited web page to HTA Application 110. In step 390, HTA Application 110 loads the edited web page of step 270 into the IFRAME, and Flash Application 140 displays the (N) New Content Objects previously selected, using for each value of the (n) the (n)th New Content Object Address and the (n)th display attributes. Applicant's method transitions from step 390 to step 330 and continues as described herein.

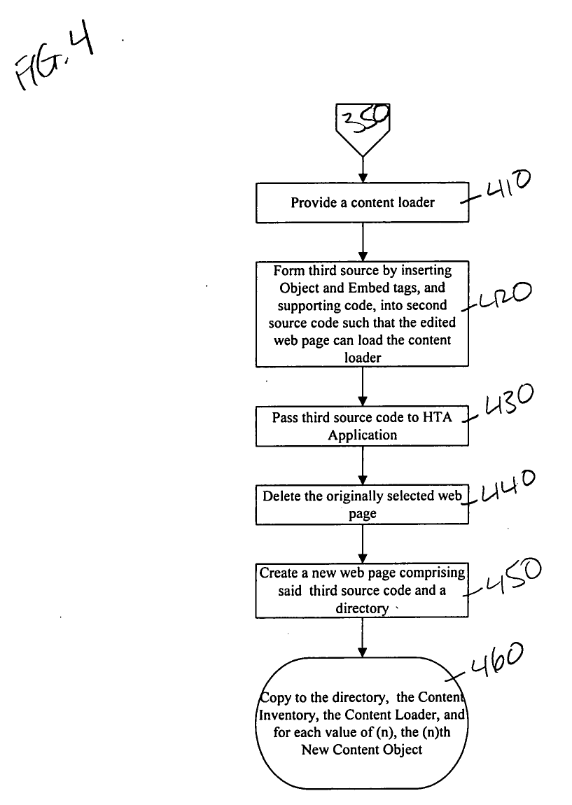

If Applicant's method elects in step 350 to publish the editing project, then the method transitions from step 350 to step 410. FIG. 4 recites the steps of Applicant's method to publish the edited web page of step 270 (FIG. 2) in combination with the (N) New Content Objects.

Referring now to FIG. 4, in step 410 the method provides a Content Loader. By “Content Loader,” Applicant means a .swf file which reads the Content Inventory .xml file and loads the content listed therein into itself, and displays each New Content Object based on the properties listed in the Content Inventory (for example, but not limited to horizontal and vertical position on the web page, and depth (layering order) relative to the other objects on the page, as well as alpha channel (individual object transparency), and the horizontal and vertical scale—the size of the object relative to its original native size). The “Content Loader” when embedded in the edited web page, with wmode tags set to transparent, displays the objects and allows the underlying web page to show through itself where none of its loaded content objects reside. In other embodiments, the Content Loader is any application that allows transparent viewing through itself, wherein that application can load external content into itself, and wherein that application can reside above an underlying web page's content.

Applicant's method transitions from step 410 to step 420 wherein Flash Application 140 revises the second source code of step 245 (FIG. 2) to form third source code by inserting Object and Embed tags, and supporting code, to embed the Content Loader into the edited web page with its wmode tags set to transparent and to enable the edited web page of step 260 to load the Content Loader of step 410. Applicant's method transitions from step 420 to step 430 wherein the method passes the third source code of step 420 as a delimited string to HTA Application 110.

Applicant's method transitions from step 430 to step 440 wherein the method deletes the originally-selected web page comprising the first source code selected in step 220. Applicant's method transitions from step 440 to step 450 wherein HTA Application 110 creates a new web page comprising the third source code received in step 430. Applicant's method transitions from step 450 to step 460 wherein HTA Application 110 reads the content inventory and copies for each value of (n) the (n)th New Content Object, the Content Inventory File, and the Content Loader, from their current locations to the same directory or subdirectory(s) of the new web page.

Subsequently, when the published new web page is displayed in a browser, the Content Loader, embedded in the new web page, reads the content inventory and displays above the published web page the (N) New Content Objects.

In certain embodiments, individual steps recited in FIGS. 2, 3, and/or 4, may be combined, eliminated, or reordered.

In certain embodiments, Applicant's invention includes instructions, such as instructions 550, residing in memory, such as memory 520 (FIG. 5), disposed in an article of manufacture, such as computing device 500 (FIG. 5), where those instructions are executed by a processor, such as processor 510 (FIG. 51), to perform one or more of steps 215, 225, 230, 240, 245, 250, 260, 270 and/or 280, recited in FIG. 2, and/or one or more of steps 315, 325, 340, 360, 370, 380, and/or 390, recited in FIG. 3, and/or one or more of steps 410, 420, 430, 440, 450, and/or 460, recited in FIG. 4.

In other embodiments, Applicant's invention includes instructions residing in a computer program product, such as computer program product 100 (FIG. 1), where those instructions are executed by a computing device, such as computing device 500 (FIG. 5), to perform one or more of steps 215, 225, 230, 240, 245, 250, 260, 270, and/or 280, recited in FIG. 2, and/or one or more of steps 315, 325, 340, 360, 370, 380, and/or 390, recited in FIG. 3, and/or one or more of steps 410, 420, 430, 440, 450, and/or 460, recited in FIG. 4. In either case, the instructions may be encoded in an information storage medium comprising, for example, a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

I claim:

1. A method to display and manipulate new content on top of an existing web page, comprising the steps of:
providing a computing device comprising a display device and an HTA application comprising an IFRAME, a single <DIV> layer, and a Flash Application embedded in said <DIV> layer;
loading a web page into said IFRAME;
loading one or more New Content Objects into said Flash Application;
displaying on said display device in a WYSIWYG format said one or more New Content Objects and said existing web page, such that said one or more New Content Objects appear on top of said existing web page.

2. The method of claim 1, further comprising the steps of:
providing an existing web page comprising first source code;
determining if said existing web page comprises one or more embedded Flash objects;
operative if said existing web page comprises one or more embedded Flash objects, forming second source code by inserting in said first source a wmode parameter tag with a value of transparent for each Flash object embedded in said existing web page.

3. The method of claim 2, further comprising the step of creating an edited web page comprising said second source code.

4. The method of claim 3, wherein said loading a web page step comprises loading said edited web page into said IFRAME.

5. The method of claim 1, wherein said providing a computing device step further comprises providing a computing device comprising one or more information storage media, said method further comprising the step of saving said edited web page to a storage location disposed on one of said one or more information storage media.

6. The method of claim 5, wherein said providing a computing device step further comprises providing a computing device comprising one or more New Content Objects written to said one or more information storage media, said method further comprising the steps of:
locating said one or more New Content Objects;
displaying on said display device said one or more New Content Objects.

7. The method of claim 5, further comprising:
selecting the (n)th New Content Object, wherein (n) is initially set to 1, and wherein said (n)th first New Content Object is one of said one or more New Content Objects, and wherein said (n)th New Content Object comprises the (n)th New Content Object Address;
establishing the (n)th display attributes for said (n)th New Content Object;
creating a Content Inventory File;
saving said (n)th New Content Object Address and said (n)th display attributes in said Content Inventory File.

8. The method of claim 7, further comprising the steps of:
determining whether to add another New Content Object;
operative if adding another New Content Object, incrementing (n) by unity;
repeating the steps of claim 7.

9. The method of claim 7, further comprising the step of saving to said Content Inventory File said storage location

10. The method of claim 7, further comprising the steps of:
providing a Content Loader;
forming third source code by inserting into said second source code object and embed tags to embed the Content Loader into the edited web page, enabling said third source code to load said Content Loader;
creating a new web page comprising said third source code and a directory;
copying, for each value of (n), to said directory the (n)th New Content Object, the Content Inventory, and said Content Loader.

11. A computer program product comprising an HTA application comprising an IFRAME, a single <DIV> layer, and a Flash Application embedded in said <DIV> layer, wherein said computer program product is usable with a programmable computer processor having computer readable program code embodied therein to display and manipulate new content on top of an existing web page, comprising:
computer readable program code which causes said programmable computer processor to load a web page into said IFRAME;
computer readable program code which causes said programmable computer processor to load one or more New Content Objects into said Flash Application;
computer readable program code which causes said programmable computer processor to display on a display device in a WYSIWYG format said one or more New Content Objects and said existing web page, such that said one or more New Content Objects appear on top of said existing web page.

12. The computer program product of claim 11, further comprising:
computer readable program code which causes said programmable computer processor to retrieve an existing web page comprising first source code;
computer readable program code which causes said programmable computer processor to determine if said existing web page comprises one or more embedded Flash objects;
computer readable program code which, if said existing web page comprises one or more embedded Flash objects, causes said programmable computer processor to form second source code by inserting in said first source a wmode parameter tag with a value of transparent for each Flash object embedded in said existing web page.

13. The computer program product of claim 12, further comprising computer readable program code which causes said programmable computer processor to create an edited web page comprising said second source code.

14. The computer program product of claim 13, further comprising computer readable program code which causes said programmable computer processor to load said edited web page into said IFRAME.

15. The computer program product of claim 11, further comprising computer readable program code which causes said programmable computer processor to save said edited web page to a storage location in an information storage medium.

16. The computer program product of claim 15, further comprising:
computer readable program code which causes said programmable computer processor to locate one or more New Content Objects written to said information storage medium;
computer readable program code which causes said programmable computer processor to display on said display device said one or more New Content Objects.

17. The computer program product of claim 15, further comprising:
computer readable program code which causes said programmable computer processor to retrieve a selected New Content Object, wherein said New Content Object comprises a New Content Object Address;
computer readable program code which causes said programmable computer processor to establish display attributes for said New Content Object;
computer readable program code which causes said programmable computer processor to create a Content Inventory File;
computer readable program code which causes said programmable computer processor to save said New Content Object Address and said display attributes in said Content Inventory File.

18. The computer program product of claim 17, further comprising computer readable program code which causes said programmable computer processor to save to said Content Inventory File said storage location.

19. The computer program product of claim 17, further comprising:
computer readable program code which causes said programmable computer processor to retrieve a Content Loader;
computer readable program code which causes said programmable computer processor to form third source code by inserting object and embed tags into said second source code to enable said third source code to load said Content Loader;
computer readable program code which causes said programmable computer processor to create a new web page comprising said third source code and a directory;
computer readable program code which causes said programmable computer processor to copy to said directory said New Content Object, said Content Inventory File, and said Content Loader.
